(19) United States
(12) Patent Application Publication
(10) Pub. No.: US 2006/0102745 A1
(43) Pub. Date: May 18, 2006

(54) Paint sprayer and pressure washer assembly

(76) Inventor: Shane Dexter, Humboldt, TN (US)

Correspondence Address: THE BLACK & DECKER CORPORATION, 701 EAST JOPPA ROAD, TW199, TOWSON, MD, 21286, US

(21) Appl. No.: 11/029,177

(22) Filed: Jan. 3, 2005

Related U.S. Application Data
(60) Provisional application No. 60/533,821, filed on Dec. 31, 2003.

(51) Int. Cl. A01G 25/09; B05B 9/06; F23D 14/28; B05B 7/30

(52) U.S. Cl. 239/146; 239/337; 239/349; 239/158

(57) ABSTRACT

A paint sprayer and pressure washer assembly is comprised of a universal motor capable of operating at at least a first speed and a second speed. Further, a pump assembly is coupled to the motor for pressuring a fluid for delivery of the fluid to a surface. In use, the motor drives the pump at one of the first speed for pumping a first fluid so that the first fluid is output at a first pressure and flow rate and the second speed for pumping a second fluid so that the second fluid is output at a second pressure and flow rate.

### CROSS-REFERENCE TO RELATED APPLICATIONS

The present application claims the benefit under 35 U.S.C. 119(e) of U.S. Provisional Application Ser. No. 60/533,821, filed Dec. 31, 2003 which is herein incorporated by reference in its entirety.

### FIELD OF THE INVENTION

The present invention relates generally to the field of pressurized fluid delivery systems, and more particularly to a paint sprayer and pressure washer assembly for selectively supplying one of pressurized paint or water to a surface.

### BACKGROUND OF THE INVENTION

Pressurized fluid delivery systems, such as pressure washers, are often employed to perform various household tasks. For example, the exterior of a house may be cleaned much more efficiently as well as more thoroughly with a pressure washer than compared to the traditional method of using a hose, bucket and scrub brush. In addition, such systems are commonly employed to perform other household tasks such as preparing a surface for painting or the cleaning of a walkway or vehicle.

Although currently available pressure washer systems have greatly increased the ease and efficiency in which a given area may be cleaned, such systems are still limited in certain situations. For instance, if a user wishes to paint a given surface, at least two different tools must be employed. First, a pressure washer may be utilized to prepare the surface for painting whereby dirt and grime as well as old, delaminated paint may be removed by the pressurized fluid. Then, an additional system must be used to deliver the paint (e.g. an automated paint sprayer) onto the desired surface. As such, the user is required to purchase multiple tools as well as find storage space to store the tools when the tools are not in use.

Therefore, it would be desirable to design a pressurized fluid delivery system which may function as a pressure washer as well as a paint sprayer allowing a surface area to be prepared and painted with use of a single tool.

### SUMMARY OF THE INVENTION

In a first aspect of the invention, a paint sprayer and pressure washer assembly is disclosed. Such system is comprised of a universal motor capable of operating at at least a first speed and a second speed. Further, a pump assembly is coupled to the motor for pressuring a fluid for delivery of the fluid to a surface. In use, the motor drives the pump at one of the first speed for pumping a first fluid so that the first fluid is output at a first pressure and flow rate and the second speed for pumping a second fluid so that the second fluid is output at a second pressure and flow rate. In additional embodiments of the present invention, the motor drives the pump at a third speed for pumping the first fluid so that the first fluid is output at a third pressure and flow rate. Alternatively, the motor may drive the pump at a fourth speed for pumping the second fluid so that the second fluid is output at a fourth pressure and flow rate. In further embodiments, the first fluid is water and the second fluid is paint. Moreover, a plurality of hoses may be coupled to the pump assembly for transporting fluid. The plurality of hoses include a first hose for transferring fluid from a source reservoir into the pump assembly and a second hose for delivering pressurized fluid to the surface. Finally, a plurality of nozzle assemblies, each capable of coupling to the second hose for delivering pressurized fluid to the surface are present. The plurality of nozzle assemblies include an assembly to spray paint or sealant and an assembly to spray water.

In a second aspect of the invention, a paint sprayer and pressure washer assembly with a transmission system is disclosed. Such system is comprised of a motor. The transmission system is coupled to the motor for regulating the speed of the motor. A pump assembly is coupled to the transmission system for pressuring a fluid for delivery of the fluid to a surface. In use, the transmission system operates the pump assembly for pumping a first fluid so that the first fluid is output at at least a first pressure and/or flow rate and a second fluid so that the second fluid is output at at least a second pressure and/or flow rate.

### BRIEF DESCRIPTION OF DRAWINGS

The numerous advantages of the present invention may be better understood by those skilled in the art by reference to the accompanying figures in which:

FIG. 1 is an isometric view of a paint sprayer and pressure washer assembly in accordance with an exemplary embodiment of the present invention;

FIG. 2 is an isometric view of the paint sprayer and pressure washer assembly illustrated in FIG. 1, wherein a hose for supplying pressurized water to a surface is connected to the paint sprayer and pressure washer assembly;

FIG. 3 is an isometric view of the paint sprayer and pressure washer assembly illustrated in FIG. 1, wherein a hose for supplying pressurized paint to a surface is connected to the paint sprayer and pressure washer assembly

FIG. 4 is a flow diagram illustrating a paint sprayer and pressure washer including a motor assembly and a pump assembly; and

FIG. 5 is a flow diagram illustrating a paint sprayer and pressure washer including a transmission system in addition to a motor assembly and a pump assembly.

### DETAILED DESCRIPTION OF THE INVENTION

Reference will now be made in detail to the presently preferred embodiments of the invention, examples of which are illustrated in the accompanying drawings.

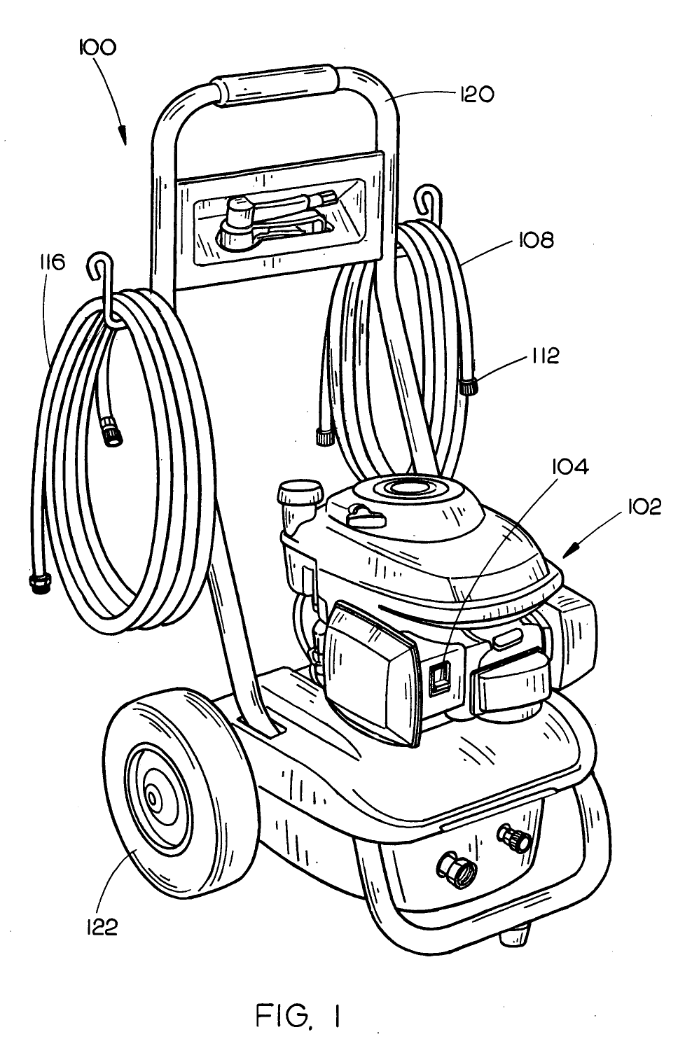

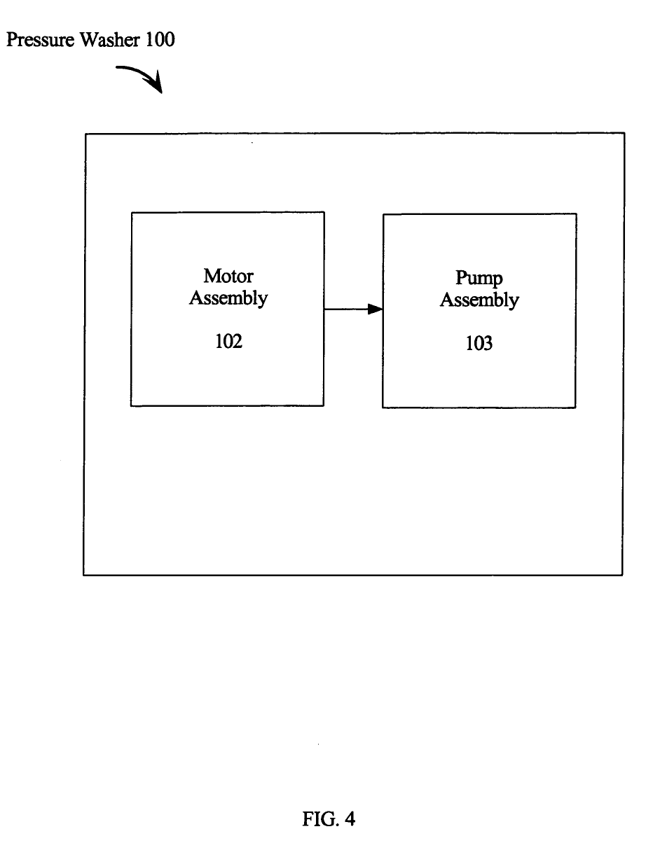

Referring to FIGS. 1-4, a paint sprayer and pressure washer assembly in accordance with the present invention is disclosed wherein such assembly may function as a pressure washer and a paint sprayer. The paint sprayer and pressure washer assembly 100 includes a motor assembly 102 having a motor capable of operating at different speeds. For instance, the motor may turn a drive shaft at a first speed to generate a first rotational velocity until an alternate speed is selected using a switch 104 or the like, at which point the motor may turn the drive shaft at a second speed to generate a second rotational velocity. In turn, rotational velocity is reciprocated into pressure and/or flow rate whereby a first rotational velocity generates a first pressure and/or flow rate and the second rotational velocity generates a second pressure and/or flow rate. Such configuration allows the user to use a lower speed/pressure for the expulsion of paint, preventing splattering or other undesirable effects, and a higher speed/higher pressure for preparation of a surface to be painted or the performance of other household tasks.

In exemplary embodiments of the present invention, the motor may be either a gas powered engine or an electrically powered motor. In one embodiment, the electrically powered motor comprises a universal motor. However, those of skill in the art will appreciate that the motor is not limited to a universal electric motor (e.g. an induction motor may be used also).

The drive shaft of the motor assembly 102 is connected to the pump assembly 103 for driving the pump assembly 103, pumping the fluid through the pump, and expelling the fluid at a higher pressure. For instance, the pump assembly 103 may include an oilless high pressure pump such as that disclosed in U.S. Pat. No. 6,779,987 by Dexter et al. U.S. Pat. No. 6,779,987, filed Mar. 1, 2002 and issuance on Aug. 24, 2004 is herein incorporated by reference in its entirety. In addition, U.S. Pat. No. 6,779,987 was a continuation-in-part application of the following U.S. patent application Ser. No. 09/639,435, now U.S. Pat. No. 6,431,844; Ser. No. 09/639,572 now U.S. Pat. No. 6,397,729; and Ser. No. 09/639,573 now U.S. Pat. No. 6,467,394. Said U.S. Pat. Nos. 6,431,844, 6,397,729 and 6,467,394 are herein incorporated by reference in their entirety.

By varying the speed of the motor's drive shaft, the pressure at which the pressurized fluid is expelled from the pump may also be varied. For example, the motor may be run at a first speed for expelling pressurized water onto the exterior of a house in preparation for painting of the house (e.g. 2700 to 4000 PSI) and then run at a second speed for expelling pressurized paint from the pump for coating the exterior surface (e.g. 2000 to 2800 PSI). Further, in addition to varying pressure, the flow rate at which the fluid is pumped may be regulated. For example, the flow rate may be approximately four (4) gallons per minute for expelling pressurized water onto the exterior of a house in preparation for painting of the house in comparison to approximately a one third (⅓) of a gallon per minute flow rate when expelling pressurized paint from the pump for coating the exterior surface.

It should also be noted that the motor may be run at different speeds for expelling the same fluid at varying pressures. For instance, a user of the paint sprayer and pressure washer assembly may wish to wash a car at a first pressure, the first pressure being low enough to prevent damage to paint on the car (e.g. 1300 to 2000 PSI). Alternatively, the user may wish to wash a driveway at a second pressure, the second pressure being high enough to remove dirt and debris from crevices in concrete (e.g. 2000 to 2600 PSI) or to strip away paint (e.g. 2700 to 4000 PSI). Thus, the variable speed feature not only allows the system to function as a paint sprayer and a pressure washer, but as a pressure washer capable of performing a plethora of household tasks.

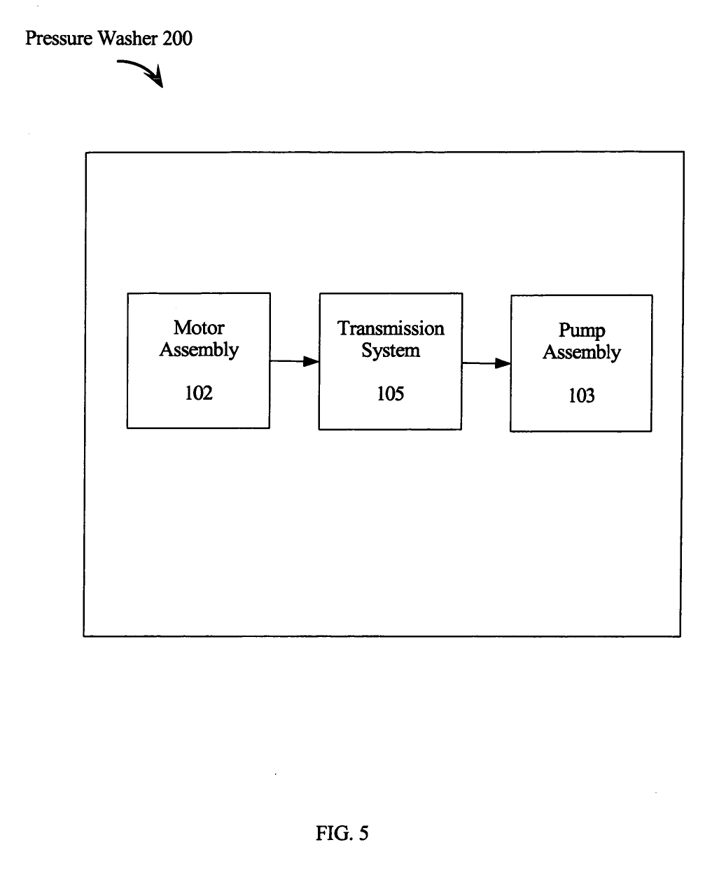

Those of skill in the art will appreciate that other techniques may be used for altering the speed of the motor's drive shaft, including the use of a variable transmission, the use of a variable electrical supply, and the like, without departing from the scope and intent of the present invention. As illustrated in FIG. 5, in an exemplary embodiment of the present invention in which a transmission system 105 is employed to vary pressure and flow rate, a motor (e.g. a universal motor) capable of operating at a single speed is utilized. The transmission system 105 is operationally coupled to the motor assembly 102 for regulating the speed of the motor. In turn, the pump assembly 103 is operationally coupled to the transmission system 105 for pressuring a fluid for delivery of the fluid to a surface, wherein the transmission system 105 operates the pump assembly 103 for pumping a first fluid so that the first fluid is output at at least a first pressure and flow rate and a second fluid so that the second fluid is output at at least a second pressure and flow rate.

The paint sprayer and pressure washer assembly 100 and 200 include various types and sizes of nozzles, tips, and guns to accomplish the desired tasks. For example, for painting of a large area, a wide angle adjustable spray tip may be coupled to a standard spray gun to allow a large surface area to be sprayed. Further, a user may employ a round spray tip to generate a different spray pattern and texture when compared to those generated with the wide angle adjustable spray tip. In contrast, if the user wishes to utilize the paint sprayer and pressure washer assembly 100 for the sealing of a deck, an adjustable stain spray tip may be coupled to a standard spray gun to deliver the water-sealant.

Alternatively, a different type of tip, nozzle, and gun including a spray wand and spray lance may be employed if the user desires to use the paint sprayer and pressure washer assembly 100 or 200 as a pressure washer. For instance, in one embodiment a standard two-finger operational gun including a trigger lock and a hose attachment end is employed. In a further embodiment, an adjustable spray wand with a hose attachment end may be utilized (e.g. to clean a vehicle). For example, the spray wand may include a lance with a spray nozzle and a guide as disclosed in U.S. patent application Ser. No. 10/626,844 filed Jul. 23, 2003 by Dexter. The guide allows a user to maintain an appropriate distance between the spray nozzle and the desired surface. U.S. patent application Ser. No. 10/626,844 filed Jul. 23, 2003 by Dexter is herein incorporated by reference in its entirety.

In additional embodiments, easy connect or quick connect fittings on the paint sprayer and pressure washer assembly 100 or 200 components are employed to make connection and disconnection of such components easier. It is contemplated that additional sizes and types of tips, nozzles, guns, or the like, may be employed without departing from the scope and spirit of the present invention.

In further embodiments of the present invention, the paint sprayer and pressure washer assembly 100 or 200 includes a plurality of hoses. In one embodiment, a first high-pressure hose 108 of variable length is coupled to the pump assembly as well as a gun 110 or wand assembly (not shown), allowing the pressurized fluid to be expelled from the assembly to the desired area. It is desirable to have a long hose (e.g. twenty-five feet) to allow for extended multi-story use. Further, it is contemplated that the hose 108 is coupled to the various assemblies via easy connect or quick connect fittings 112 to allow easy, efficient coupling. In addition to the first high pressure hose 108, a second hose of variable length 114 is included to be placed into a paint bucket 118, reservoir, or can. Furthermore, an additional hose of variable length 116 (e.g. a garden hose or one supplied with the paint sprayer and pressure washer assembly 100 or 200) capable of coupling to an outdoor water supply (e.g. hose nozzle), or the like may be connected to the paint sprayer and pressure washer assembly 100 or 200 for supplying water to the assembly.

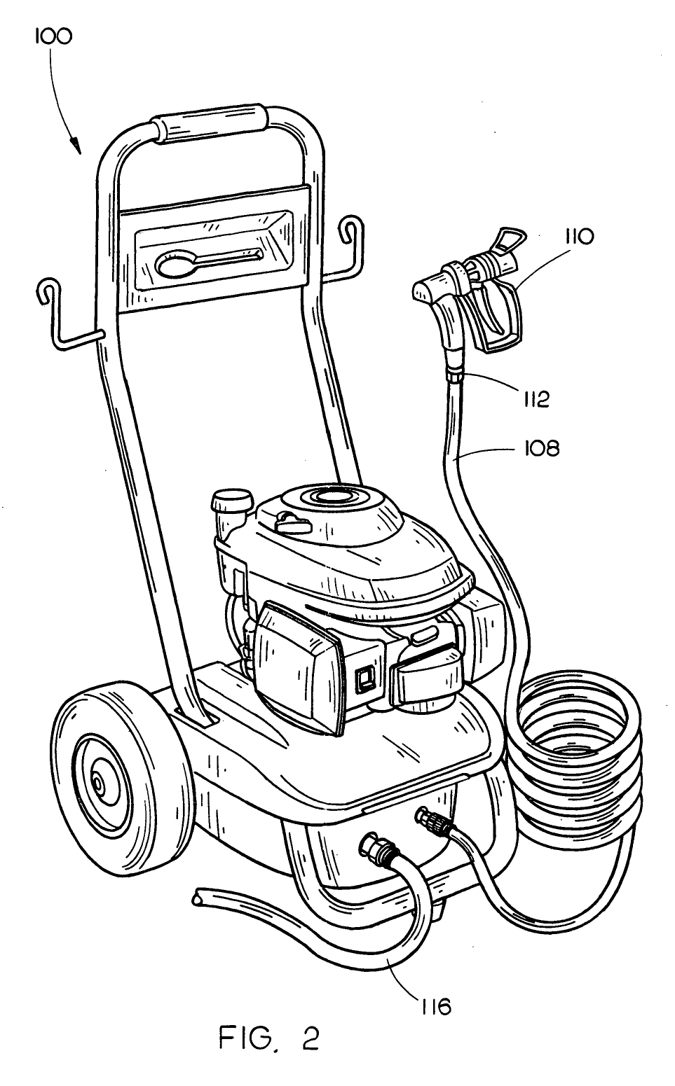

As seen in FIG. 2, the hose 116 is connected to the paint sprayer and pressure washer assembly 100 for supplying water to the assembly, the water being pressurized and delivered to a surface for cleaning. For example, the paint sprayer and pressure washer assembly 100 may be used to deliver pressurized water to siding on a house for cleaning the siding before an application of paint.

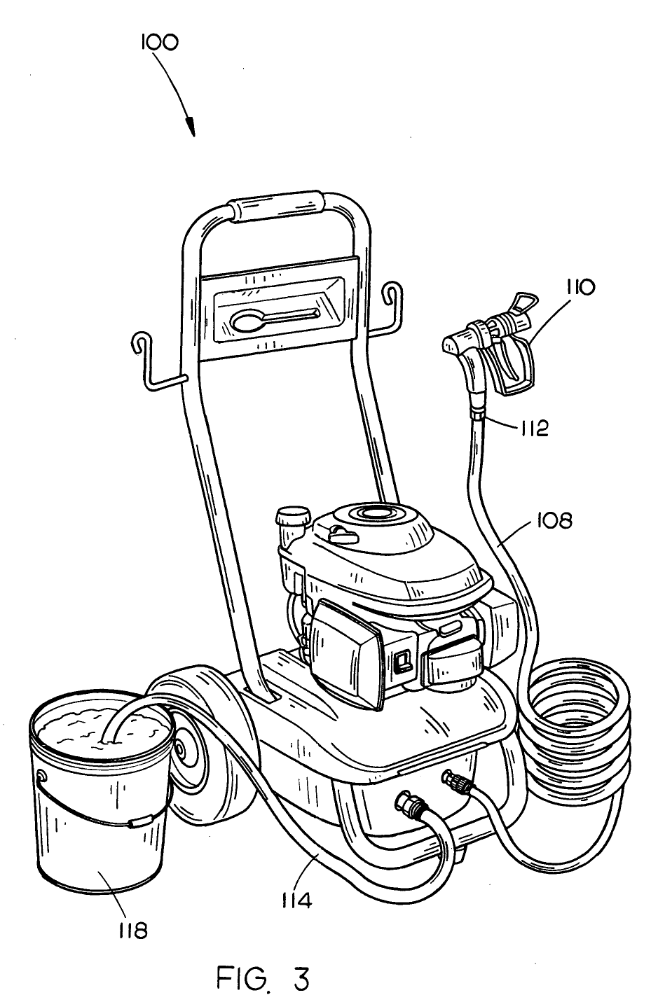

As illustrated in FIG. 3, the hose 114 may be connected to the paint sprayer and pressure washer assembly 100, terminating in the paint reservoir 118, instead of being connected to the outside water supply, for supplying paint to the assembly 100, the paint being pressurized and delivered to a surface for coating the surface. Upon completion of the application of paint to the surface, the paint sprayer and pressure washer assembly 100 may be connected to the water supply using the hose 116, or alternatively to a supply of water and detergent. By pumping the water or the water/detergent mixture through the paint sprayer and pressure washer assembly 100, the assembly 100 may be cleaned and readied for further use.

In additional embodiments of the present invention, the paint sprayer and pressure washer assembly 100 or 200 is mounted on a cart 120 with wheels (as represented by 122). Such configuration allows the paint sprayer and pressure washer assembly 100 or 200 to be easily transported. Further, the cart 120 may also be used to hang components (e.g. hoses) of the paint sprayer and pressure washer assembly 100 or 200.

It is believed that the present invention and many of its attendant advantages will be understood by the foregoing description, and it will be apparent that various changes may be made without departing from the scope and spirit of the invention or without sacrificing all of its material advantages. The form herein before described being merely an explanatory embodiment thereof, it is the intention of the following claims to encompass and include such changes.

Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

What is claimed:

1. A paint sprayer and pressure washer assembly, comprising:
a universal motor capable of operating at at least a first speed and a second speed; and
a pump assembly coupled to the motor for pressuring a fluid for delivery of the fluid to a surface,
wherein the motor drives the pump assembly at one of the first speed for pumping a first fluid so that the first fluid is output at a first pressure and flow rate and the second speed for pumping a second fluid so that the second fluid is output at a second pressure and flow rate.

2. The paint sprayer and pressure washer assembly as claimed in claim 1, wherein the motor drives the pump assembly at a third speed for pumping the first fluid so that the first fluid is output at a third pressure and flow rate.

3. The paint sprayer and pressure washer assembly as claimed in claim 1, wherein the motor drives the pump assembly at a fourth speed for pumping the second fluid so that the second fluid is output at a fourth pressure and flow rate.

4. The paint sprayer and pressure washer assembly as claimed in claim 1, wherein the first fluid is water.

5. The paint sprayer and pressure washer assembly as claimed in claim 1, wherein the second fluid is paint.

6. The paint sprayer and pressure washer assembly as claimed in claim 1, further comprising a plurality of hoses coupled to the pump assembly for transporting fluid.

7. The paint sprayer and pressure washer assembly as claimed in claim 6, further comprising a plurality of nozzle assemblies capable of coupling with the plurality of hoses.

8. The paint sprayer and pressure washer assembly as claimed in claim 7, wherein the plurality of nozzle assemblies includes an assembly to spray paint or sealant and an assembly to spray water.

9. A paint sprayer and pressure washer assembly, comprising:
a motor;
a transmission system coupled to the motor, for regulating the speed of the motor; and
a pump assembly coupled to the transmission system for pressuring a fluid for delivery of the fluid to a surface, the transmission system for regulating the speed of the pump,
wherein the transmission system operates the pump assembly for pumping a first fluid so that the first fluid is output at at least a first pressure and flow rate and a second fluid so that the second fluid is output at at least a second pressure and flow rate.

10. The paint sprayer and pressure washer assembly as claimed in claim 9, wherein the motor is a universal motor.

11. The paint sprayer and pressure washer assembly as claimed in claim 9, wherein the transmission operates the pump assembly so that the first fluid is output at a third pressure and flow rate.

12. The paint sprayer and pressure washer assembly as claimed in claim 9, wherein the transmission operates the pump assembly so that the second fluid is output at a fourth pressure and flow rate.

13. The paint sprayer and pressure washer assembly as claimed in claim 9, wherein the first fluid is water.

14. The paint sprayer and pressure washer assembly as claimed in claim 9, wherein the second fluid is paint.

15. The paint sprayer and pressure washer assembly as claimed in claim 9, further comprising a plurality of hoses coupled to the pump assembly for transporting fluid.

16. The paint sprayer and pressure washer assembly as claimed in claim 15 further comprising a plurality of nozzle assemblies capable of coupling with the plurality of hoses.

17. The paint sprayer and pressure washer assembly as claimed in claim 16 wherein the plurality of nozzle assemblies includes an assembly to spray paint or sealant and an assembly to spray water.

18. A paint sprayer and pressure washer assembly, comprising:
a motor assembly for providing power to the paint sprayer and pressure washer assembly, the motor assembly including a universal motor operating at at least a first speed and a second speed; and
a pump assembly coupled to the motor assembly for pressuring a fluid for delivery of the fluid to a surface,
wherein the motor drives the pump at one of the first speed for pumping a first fluid so that the first fluid is output at a first pressure and flow rate, the first fluid including water and the second speed for pumping a second fluid so that the second fluid is output at a second pressure, the second fluid including paint.

19. The paint sprayer and pressure washer assembly as claimed in claim 18, wherein the motor drives the pump at a third speed for pumping the first fluid so that the first fluid is output at a third pressure and flow rate.

20. The paint sprayer and pressure washer assembly as claimed in claim 18, wherein the motor drives the pump at a fourth speed for pumping the second fluid so that the second fluid is output at a fourth pressure and flow rate.
